(19) United States
(12) Patent Application Publication
(10) Pub. No.: US 2026/0371208 A1
(43) Pub. Date: Nov. 19, 2026

(54) RADIO LINK FAILURE AND HANDOVER FAILURE IN LAYER 1/LAYER 2 MOBILITY

(71) Applicant: Apple Inc., Cupertino, CA (US)

(72) Inventors: Naveen Kumar R. Palle Venkata, San Diego, CA (US); Fangli Xu, Beijing (CN); Sethuraman Gurumoorthy, San Ramon, CA (US); Haijing Hu, Los Gatos, CA (US); Yuqin Chen, Beijing (CN); Ralf Rossbach, Munich (DE); Ping-Heng Kuo, London (GB); Peng Cheng, Beijing (CN); Zhibin Wu, Los Altos, CA (US); Alexander Sirotkin, Tel-Aviv (IL)

(73) Assignee: Apple Inc., Cupertino, CA (US)

(21) Appl. No.: 19/155,864

(22) PCT Filed: Feb. 13, 2023
(86) PCT No.: PCT/CN2023/075637

§ 371 Date: Aug. 12, 2025

(51) Int. Cl. H04W 36/30; H04W 36/08

(52) U.S. Cl. CPC H04W 36/305; H04W 36/08

(57) ABSTRACT

Techniques for layer 1 (L1)/layer 2 (L2) triggered mobility (LTM)-based failure handling are provided. An example method includes a user equipment (UE) detecting a failure, the failure being a radio link failure (RLF) or a handover (HO) failure. The UE can detect a cell configured for LTM based on the detection of the failure. The UE can transmit, to the cell using a signaling radio bearer one (SRB1), a radio resource control (RRC) reestablishment message, the RRC reestablishment message including a UE identifier and a failure cause. The UE can recover packet data convergence protocol (PDCP) data for one or more signaling radio bearers (SRBs) and suspending PDCP data for one or more data radio bearers (DRBs).

### TECHNICAL FIELD

The present disclosure generally relates to wireless communication, and in particular, to radio link failure and handover failure in layer 1/layer 2 mobility.

### BACKGROUND

Cellular communications can be defined in various standards to enable communications between a user equipment and a cellular network. For example, long-term evolution (LTE) and Fifth generation (5G) networks are defined by wireless standards that aim to improve upon data transmission speed, reliability, availability, and more.

### BRIEF DESCRIPTION OF THE DRAWINGS

FIG. 1 is an illustration of a layer 1 (L1)/layer 2 (L2) triggered mobility (LTM) radio link failure (RLF), according to one or more embodiments.

FIG. 2 is an illustration of an LTM handover (HO) failure, according to one or more embodiments.

FIG. 3 is a signaling diagram for LTM failure reporting in a master cell group (MCG), according to one or more embodiments.

FIG. 4 is a signaling diagram for failure reporting in an MCG, according to one or more embodiments.

FIG. 5 is a signaling diagram for failure reporting in a secondary cell group (SCG), according to one or more embodiments.

FIG. 6 is a signaling diagram for failure reporting in a SCG, according to one or more embodiments.

FIG. 7 is an example SON/MDT report, according to one or more embodiments.

FIG. 8 is an example SON/MDT report, according to one or more embodiments.

FIG. 9 is a process flow for RRC-based LTM failure handling in an MCG, according to one or more embodiments.

FIG. 10 is a process flow for MAC CE-based LTM failure handling in an MCG, according to one or more embodiments.

FIG. 11 is a process flow for MAC CE-based LTM failure handling in an SCG, according to one or more embodiments.

FIG. 12 is a process flow for RRC-based LTM failure handling in an MCG, according to one or more embodiments.

FIG. 13 illustrates an example of receive components, according to one or more embodiments.

FIG. 14 illustrates an example of a UE, according to one or more embodiments.

FIG. 15 illustrates an example of a base station, according to one or more embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “base station” as used herein refers to a device with radio communication capabilities, that is a network component of a communications network (or, more briefly, a network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “network” as used herein reference to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “3GPP Access” refers to accesses (e.g., radio access technologies) that are specified by 3GPP standards. These accesses include, but are not limited to, GSM/GPRS, LTE, LTE-A, 5G NR, and/or 6G. In general, 3GPP access refers to various types of cellular access technologies.

The term “Non-3GPP Access” refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted.” Trusted non-3GPP accesses can interact directly with an evolved packet core (EPC) and/or a 5G core (5GC), whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

A handover (HO) can be a procedure whereby a user equipment (UE) connection is transferred over from one base station providing service for one cell to another base station providing service for another cell. Traditionally an HO in a cellular network occurs when a UE moves from one cell to another cell using a layer 3 (L3) procedure.

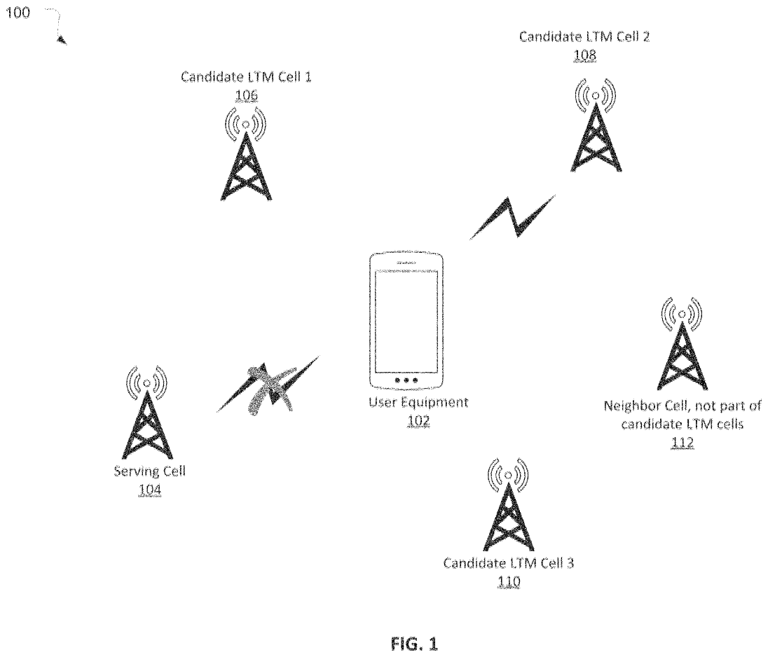

FIG. 1 is an illustration 100 of an LTM-based on a radio link failure (RLF), according to one or more embodiments. A UE 102 can be camped in a serving cell 104. A base station of the serving cell 104 can configure the UE 102 with multiple candidate LTM cells (e.g., candidate LTM cell 1 106, candidate LTM cell 2 108, and candidate LTM cell 3 110). For example, a base station can configure the UE 102 with the candidate LTM cells using a radio resource control (RRC) message.

In some instances, there can be a connection issue between the UE 102 and the serving cell 104, such as an RLF. In response to the connection issue, the UE 102 can search neighboring cells to establish a connection with another cell from a group of candidate cells. The candidate cells can include candidate LTM cells (e.g., candidate LTM cell 1 106, candidate LTM cell 2 108, and candidate LTM cell 3 110) and candidate cells are LTM cells (e.g., neighboring cell, not part of candidate LTM cells 112). In some instances, the candidate LTM cells can have priority over candidate non-LTM cells. In instances that the UE 102 elects to establish a connection with a candidate LTM cell, the procedure is different than if the UE 102 elects to establish a connection with a candidate cell that is not an LTM cell.

If the UE 102 determines that a candidate LTM cell includes the appropriate criteria, a distributed unit (DU) of the base station can transmit a medium access control-control element (MAC CE) message to the UE 102 to trigger the LTM HO (e.g., with the candidate LTM cell 2 108). The MAC CE command can include the target candidate LTM cell's configuration. The UE 102 can initiate an RRC message with the target LTM cell to establish a connection. It should be appreciated that a context of the UE 102 from when the UE 102 received the configurations for the multiple candidate LTM cells to when the UE 102 receiveed the MAC CE command can have changed.

In some instances, the UE 102 cannot comply with the target candidate LTM cell configuration at the time of receiving the MAC CE command. For example, there can be a configuration validation failure. Even though the UE 102 cannot comply with the MAC CE command, the UE does not have the functionality to report the inability to comply to the base station in an LTM scenario. Therefore, the UE 102 cannot provide information to a centralized unit (CU) of the serving cell base station about the inability to comply with the MAC CE command in the LTM scenario. If the CU was provided this information, the CU could prepare candidate DUs (e.g., a DU at a base station at a candidate LTM cell) to mitigate this situation. However, currently there is no mechanism for the UE to provide the CU with this information.

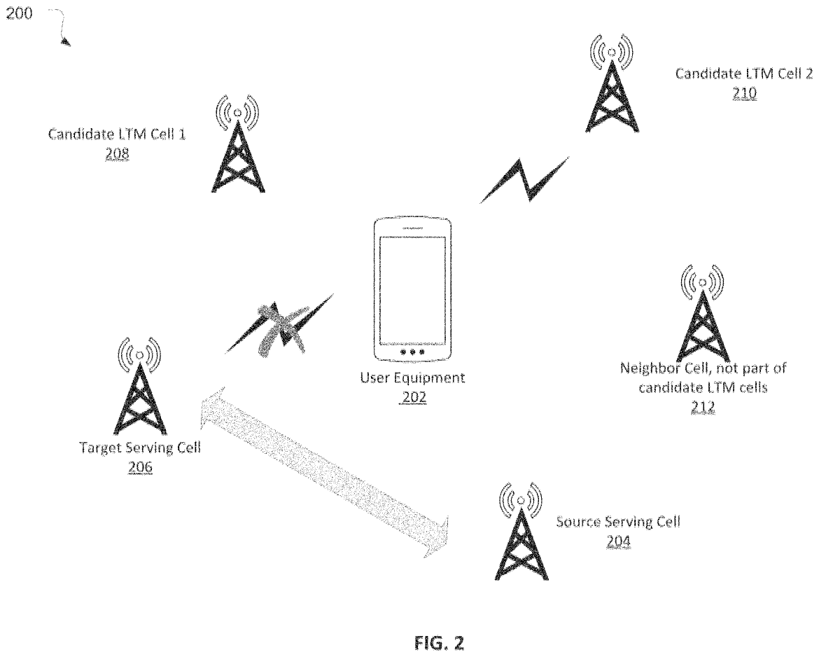

FIG. 2 is an illustration of an LTM-based on a HO failure, according to one or more embodiments. As illustrated, there can be an RRC connection issue between the UE 202 and the source serving cell 204, and the UE 102 can experience an issue during an HO from the source serving cell 204 to a target serving cell 206. In response, the UE 202 can search neighboring cells to establish a connection with another cell. The candidates cells can include, for example, target serving cell 206, candidate LTM cell 1 208, candidate LTM cell 2 210, and neighboring cell, not part of candidate LTM cells 212). After the UE 202 finds a suitable candidate cell (e.g., target serving cell 206), the UE 202 can initiate an RRC message with the target LTM cell to establish a connection.

In some instances, the HO from the source serving cell 204 to the target serving cell 206 fails. In these instances, the UE 202 can attempt to search for the source serving cell 204 to reestablish a connection. If the UE 202 finds the source serving cell 204, the UE 202 can send an RRC message to reestablish a connection. If the UE 202 does not find the source serving cell 204, the UE 202 can search for other candidate cells (e.g., candidate LTM cell 1 208, candidate LTM cell 2 210, and neighboring cell, not part of candidate LTM cells 212).

In instances that the UE 202 elects to establish a connection with a candidate LTM cell, the procedure is different than if the UE 202 elects to establish a connection with a candidate non-LTM cell.

It is still for further study as to whether a conditional HO-based LTM will be allowed in 3GPP release 18. Currently, if an LTM based MAC CE for LTM is to be transmitted, a centralized unit (CU) would have co-coordinated with a source distributed unit (DU) and target DO about a potential LTM HO or connected based on an LTM RLF. The CU would have provided the necessary trigger condition for the source DU to provide the LTM MAC CE. It is, however, still for further study whether the source DU can make decisions on its own or does the CU make the runtime decision for the DU. In any case, the CU should be informed about a failure. Furthermore, the CU needs to inform the DU to potentially prepare candidate DUs for the UE. There would be no need for a security reset as long as the UE selects a candidate DU.

The embodiments herein are directed toward mechanism and procedures for layer 1 (L1), layer (L2) procedures for inter-cell mobility with reduced mobility latency. A UE (e.g., the UE 102 of FIG. 1 or the UE 202 of FIG. 2), can be configured to report a failure in the instance of an RL failure or a HO failure. It should be appreciated that in the instance of an RL failure, there is a possibility that the radio link control (RLC) packets are not affected if the UE is using carrier aggregation (CA). As indicated above, in the event of an RL failure or an HO failure, the UE can search for a suitable candidate cell. If the candidate cell satisfies the UE's cell selection criteria and the candidate cell is an LTM cell, the UE can generate message includes a UE identity (e.g., cell radio network temporary identifier (C-RNTI), a current physical cell ID (PCI), ShortMac-1) and a new cause for the failure (e.g., LTM reconfiguration failure, LTM HO failure). For example, the LTM reconfiguration cause can be included if there was an attempted HO that the UE could not comply with the target cell configuration. The LTM HO failure cause can be included if, for example, the UE could comply with the target cell configuration, but for some reason that the UE could not synchronize with the target cell. The UE can further wait for a response and proceed as instructed by the response. In some instances, the UE can initiate a timer and respond in accordance with whether a response message is received prior to expiration of the timer or if no message is received upon expiration of the timer.

In the above embodiments, it is assumed that the UE and the selected candidate cell are both configured for LTM. In some embodiments, the UE is configured for LTM, however, the selected candidate cell is not configured for LTM. In this instance, the UE can resort to a legacy operation of RRC connection reestablishment to establish a connection with the selected candidate cell.

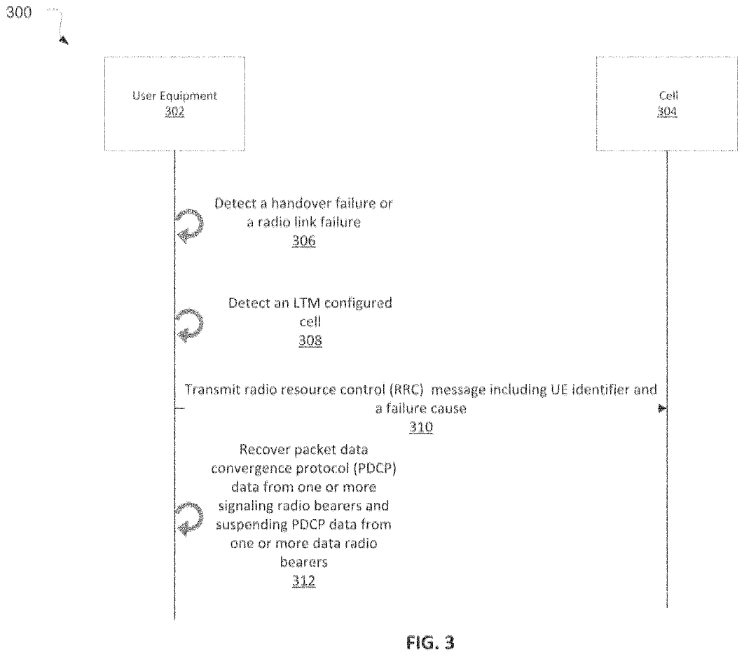

FIG. 3 is a signaling diagram 300 for failure reporting in a master cell group (MCG), according to one or more embodiments. As illustrated a UE 302 can be in operable communication with a cell. The UE 302 can be an LTM-configured UE and the cell 304 can be an LTM-configured cell in an MCG. At 306, the UE 302 can detect a failure, such as an LTM HO failure, such as between a source serving cell and a target serving cell or an LTM RLF, such as at a serving cell.

At 308, the UE 302 can detect a cell 304 from a set of candidate cells. For example, the UE 302 can begin searching candidate cells for a cell that meets suitable cell selection criteria. In some instances, the UE 302 is configured with a list of candidate cells that are configured for LTM. The configurations can be received by the UE through RRC messaging. In some instances, the UE 302 is further configured to give LTM-configured cells priority when selecting a cell from a set of candidate cells.

At 310, the UE 302 can transmit an RRC message to the cell 304 that includes a UE identifier and a failure cause. In some instances, the message is a legacy RRC reestablishment message that is modified for LTM. The UE identifier can include, for example, a C-RNTI, a PCI, or a short-MAC-I. The failure cause can include an LTM reconfiguration failure or an LTM HO failure.

The message can be transmitted using a signaling radio bearer one (SRB1). It should be appreciated that the RLC entity may be unaligned with this approach, for example, in a situation in which carrier aggregation (CA) is not being used.

At 312, the UE 302 can recover packet data convergence protocol (PDCP) data for one or more signaling radio bearers (SRBs) and suspend PDCP data for one or more data radio bearers (DRBs). The UE does not, however, reestablish any RLC entity that has been terminated due to the failure.

The UE 302 can further start a timer to be used to determine whether to perform a legacy procedure. As the timer is counting, the UE 302 can wait for an RRC reconfiguration message from the network. The RRC reconfiguration message can provide instructions for whether to restablish one or more data radio bearers (DRBs) or one or more SRBs. If the RRC reconfiguration message is received prior to the expiration of the timer, the UE 302 can proceed as indicated by the RRC reconfiguration message. If, however, the timer expires prior to receiving the RRC reconfiguration message, the UE can resort to a legacy procedure.

In some embodiments, the message can be a newly defined message transmitted at step 308 or a modified RRC reconfiguration complete message. In these instances, the message can include a new field indicating, for example, that the HO did not complete or that there was an RL failure selection. The message can further include a UE identifier (e.g., C-RNTI, PCI, or short-MAC-I). In some instances, a UE identifier is selected to preserve the privacy of the user. For example, the PCI can be used to determine the physical location of the UE 302 at a point in time. Therefore, rather than include the PCI in the message, the UE 302 can include a preconfigured identity, such that the UE 302 can be identified using the preconfigured identity. The message can further include a failure cause (e.g., LTM reconfiguration failure, LTM HO failure, or LTM RL failure.) In these embodiments, the UE 302 does not reestablish any RLC entity that has been terminated. The UE 302 does recover PDCP data for SRBs but suspends PDCP data for DRBs.

As above, the UE 302 can start a timer to be used to determine whether to perform a legacy procedure. As the timer is counting, the UE 302 can wait for an RRC reconfiguration message from the network. The RRC reconfiguration message can provide instructions for whether to restablish one or more data radio bearers (DRBs) or one or more SRBs. If the RRC reconfiguration message is received prior to the expiration of the timer, the UE 302 can proceed as indicated by the RRC reconfiguration message. If, however, the timer expires prior to receiving the RRC reconfiguration message, the UE can resort to a legacy procedure.

In some embodiments, the UE can perform a legacy operation of RRC connection and reestablishment in response to an LTM failure.

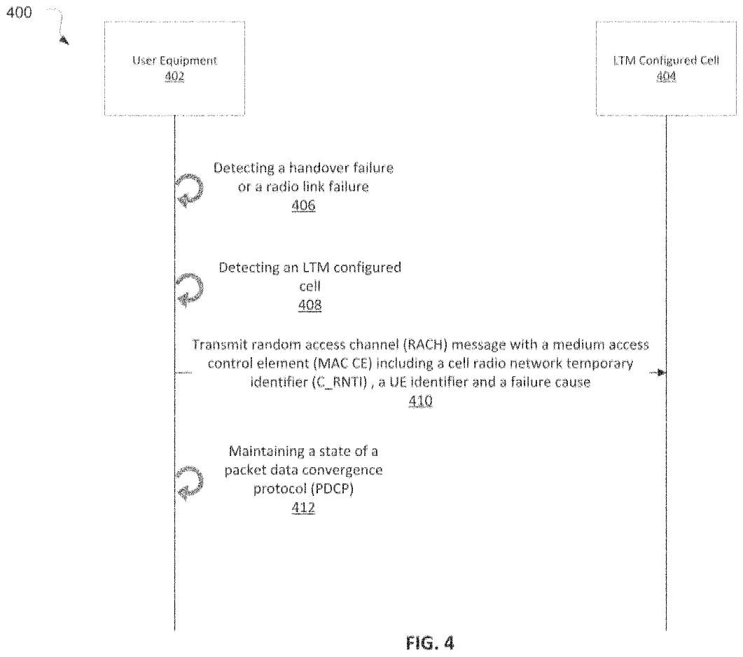

FIG. 4 is a signaling diagram 400 for failure reporting in an MCG, according to one or more embodiments. As illustrated a UE 402 can be in operable communication with a cell 404. The UE 402 can be an LTM-configured UE and the cell 404 can be an LTM-configured cell in an MCG. At 406, the UE 402 can detect a failure, such as an LTM HO failure, such as between a source serving cell and a target serving cell or an LTM RLF, such as at a serving cell.

At 408, the UE 402 can detect a cell 404 from a set of candidate cells. For example, the UE 402 can begin searching candidate cells for a cell that meets suitable cell selection criteria. In some instances, the UE 402 is configured with a list of candidate cells that are configured for LTM. The configurations can be received by the UE through RRC messaging. In some instances, the UE 402 is further configured to give LTM-configured cells priority when selecting a cell from a set of candidate cells.

At 410, the UE 402 can transmit a message to the cell 404 that includes a UE identifier and a failure cause. The message can be a random access channel (RACH) message of a series of RACH messages. Message 3 of the series of RACH messages can include a MAC CE that includes a C-RNTI, UE identifier the PCI of the source cell. The message 3 can further include a failure cause, such as an LTM HO failure, an LTM reconfiguration failure, and an RL failure.

The UE 402 can start a timer to be used to determine whether to perform a legacy procedure. The timer can be similar to a T304 timer, or the timer can be a new timer configured for LTM. As the timer is counting, the UE 302 can wait for an RRC reconfiguration message from the network.

At 412, the UE can maintain the state of the PDCP data. Furthermore, based on the target cell's configuration the RLC entity can remain. The RRC reconfiguration message can provide instructions for whether to restablish one or more data radio bearers (DRBs). If the RRC reconfiguration message is received prior to the expiration of the timer, the UE 402 can proceed as indicated by the RRC message. Alternatively to receiving the RRC message, the UE 402 can receive a physical downlink control channel scheduling using the C-RNTI.

If, however, the timer expires prior to receiving the RRC reconfiguration message, the UE can transmit a message to the RRC to report the failure. The RRC can perform actions similar to actions performed by lower layers in response to an RLF. The timer can be managed across different layers in the RRC layer, the MAC layer, and the physical (PHY) layer.

In some embodiments, the information provided by the MAC CE can be confirmed by a new MAC CE. As indicated above, the MAC CE can include the PCI of the source cell, that can provide location information. Therefore, rather than include the PCI in the message, the UE 402 can include a preconfigured identity, such that the UE 402 can be identified using the preconfigured identity.

In some embodiments, the network can configure to UE 402 to use RRC-based failure handling or MAC CE-based failure handling.

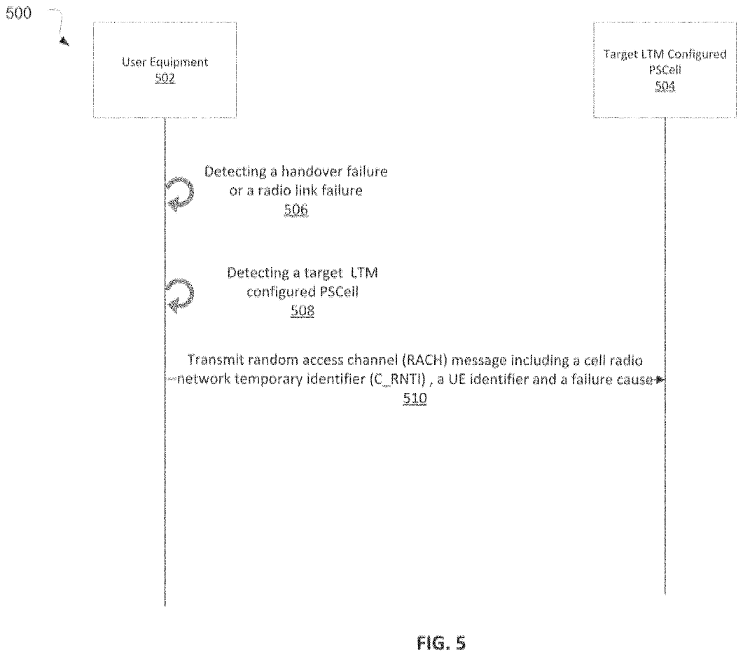

FIG. 5 is a signaling diagram 500 for failure reporting in a secondary cell group (SCG), according to one or more embodiments. As illustrated a UE 502 can be in operable communication with a cell 504. The UE 502 can be an LTM-configured UE and the cell 504 can be an LTM-configured primary cell in a SCG (PSCell). At 506, the UE 502 can detect a failure, such as a PSCell change failure or an SCG PSCell RLF.

At 508, the UE 502 can detect a cell 504 from a set of candidate cells. For example, the UE 502 can begin searching candidate cells in an SCG for a cell that meets suitable cell selection criteria to proactively connect to a target PSCell. In some instances, the UE 502 is configured with a list of candidate cells that are configured for LTM. The configurations can be received by the UE through RRC messaging. In some instances, the UE 502 is further configured to give LTM-configured cells priority when selecting a cell from a set of candidate cells.

At 510, the UE 502 can transmit a message to the cell 504 that includes a UE identifier and a failure cause. The message can be a random access channel (RACH) message of a series of RACH messages. Message 3 of the series of RACH messages can include a MAC CE used to set up context between a DU and a CU. The message 3 includes a C-RNTI, UE identifier the PCI of the source PScell. The message 3 can further include a failure cause, such as an LTM HO failure or an LTM reconfiguration failure.

The UE 502 can start a MAC timer to be used to determine whether to perform a legacy procedure. As the timer is counting, the UE 302 can wait for an RRC reconfiguration message from the network.

At 512, the UE can maintain the state of the PDCP data and the state of the RLC entity. The RRC reconfiguration message can provide instructions for whether to reestablish one or more data radio bearers (DRBs). If the RRC reconfiguration message is received prior to the expiration of the timer, the UE 502 can proceed as indicated by the RRC message.

Alternatively, to receiving the RRC message, the UE 502 can receive a physical downlink control channel scheduling using the C-RNTI.

If, however, the timer expires prior to receiving the RRC reconfiguration message, the UE 502 can perform a legacy operation of RRC connection reestablishment. The UE 502 can further release the current context (including security), apply a default configuration, and apply the source cell security.

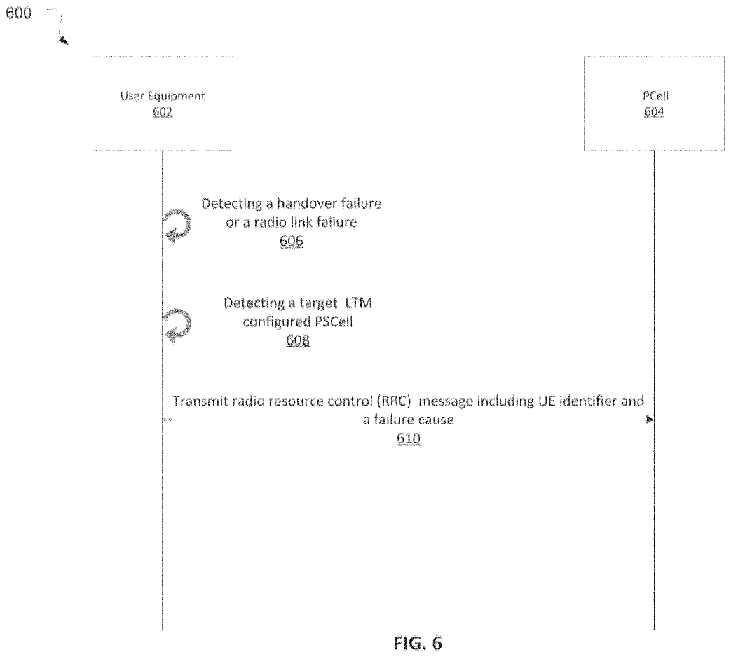

FIG. 6 is a signaling diagram 600 for failure reporting in a SCG, according to one or more embodiments. As illustrated, a UE 602 can be in operable communication with a cell. The UE 602 can be an LTM-configured UE and the cell 604 can be an LTM-configured primary cell (PCell). At 606, the UE 602 can detect a failure, such as a PSCell change failure or an SCG PSCell RLF.

At 608, the UE 602 can detect a cell (e.g., a PSCell) from a set of candidate cells.

For example, the UE 602 can begin searching candidate cells for a cell that meets suitable cell selection criteria. The UE 602 can take measurements from a plurality of candidate cells to determine the suitability of each cell based on a selection criteria. In some instances, the UE 602 is configured with a list of candidate cells that are configured for LTM. The configurations can be received by the UE through RRC messaging. In some instances, the UE 602 is further configured to give LTM-configured cells priority when selecting a cell from a set of candidate cells.

At 610, the UE 602 can transmit, to the PCell 604, an RRC message using an SCG failure information information element (IE) with modifications. The SCG failure information IE can include that includes failure cause, such as an LTM reconfiguration failure or an LTM HO failure.

At 612, the UE 602 does not restablish any terminated RLC entity. The UE 602 can recover the PDCP data for SRBs and not suspend the DRBs.

The UE can wait for a new RRC message from the PCell 604 for reconfiguration instructions. The RRC message can include instructions for reestablishing the DRBs.

In some embodiments, the UE 602 can reuse legacy SCG failure procedure, and include the new failure cause (e.g., LTM reconfiguration failure or an LTM HO failure). In some embodiments, the UE 602 can further transmit measurements of the candidate LTM cells, if available.

In some embodiments, the UE 602 uses a legacy procedure regardless if the PSCell is an LTM cell or not. In yet another embodiment, a network can configure the UE as to which actions to take in with regard to failure handling.

A UE configured for LTM can take action in response to an RLF or an HO failure at a PCell during an LTM HO. In the instance of an RLF, there is a possibility that the RLC packets would not be affected if the UE is in CA.

In the instance of a failure at the PCell, a UE configured with multiple candidate LTM cells can search candidate cells, including the LTM cells for a cell that meets a cell selection criteria. The UE can select an LTM cell based on the selection criteria. The UE can create a legacy RRC message with modifications, including a UE identity and a failure cause. The UE can further start a timer and wait for an RRC response message with reconfiguration instructions. The UE can further apply the configuration of a selected LTM cell, rather than a default cell configuration. The UE can further use timers for a HO procedure to the selected LTM cell.

Alternatively, the UE configured with multiple candidate LTM cells can search candidate cells, including the LTM cells for a cell that meets a cell selection criteria. The UE can select an LTM cell based on the selection criteria. The UE can perform MAC actions as an LTM MAC CE-based HO is performed. The UE can transmit a random access channel (RACH) message of a series of RACH messages. Message 3 of the series of RACH messages can include a MAC CE used to set up context between a distributed unit (DU) and a centralized unit (CU). The UE can start a MAC timer and wait for an RRC message from the network. If the UE receives the RRC message prior to the expiration of the timer, the UE can further apply the configuration of a selected LTM cell, rather than a default cell configuration. If the timer expires prior to receiving the RRC reconfiguration message, the UE can inform the RRC of the failure. The RRC can perform actions that are similar to RLF from lower layers.

In some embodiments, the network can configure the UE to select an LTM cell from a set of candidate cells or not choose the LTM cell from the set of candidate cells.

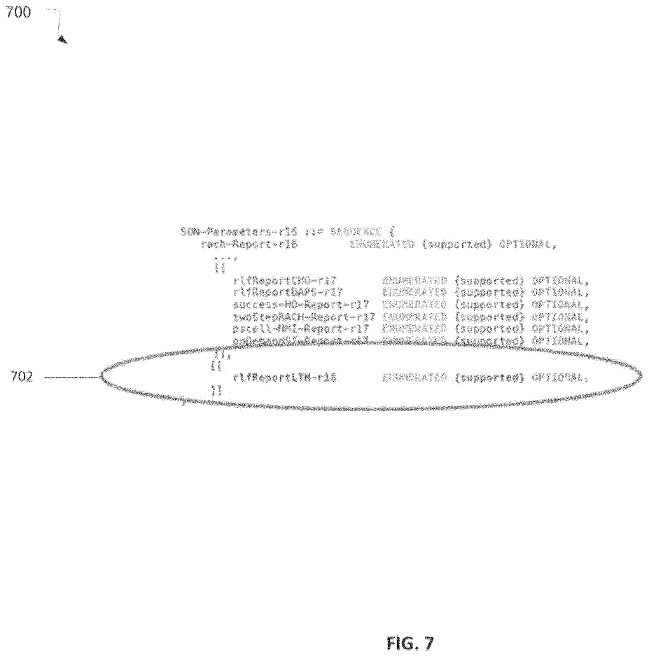

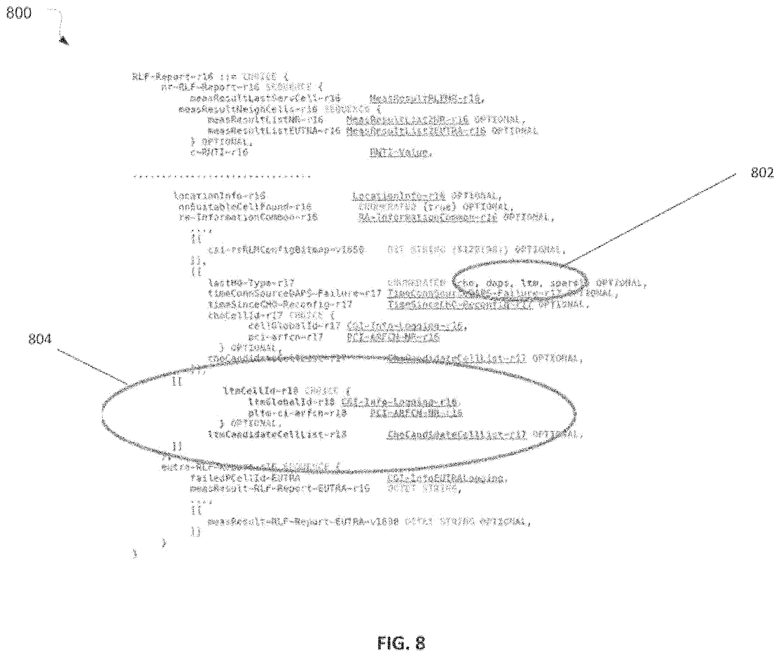

FIGS. 7 and 8 include SON/MDT reports related to LTM-based failure handling. FIG. 7 is an example SON/MDT report 700, according to one or more embodiments. For example, the report 700 can include an indication 702 that the report 700 includes an LTM-based RLF IE. FIG. 8 is an example SON/MDT report 800, according to one or more embodiments. As seen, the report 800 includes a first indication 802 that a HO is an LTM-based HO. The report 800 further includes a second indication 804 including an LTM-configured UE identifier and a list of candidate LTM cells.

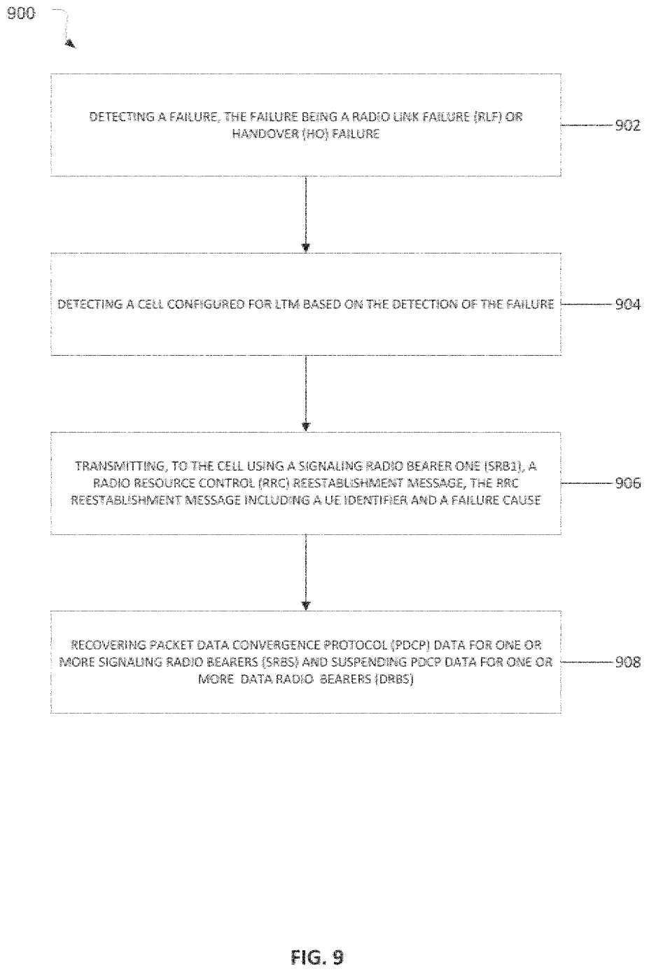

FIG. 9 is a process flow 900 for RRC-based LTM failure handling in an MCG, according to one or more embodiments. At 902, the method can include a UE detecting a failure, the failure being an RLF or an HO failure.

At 904, the method can include the UE detecting a cell configured for LTM based on the detection of the failure. The UE configured with multiple candidate LTM cells in an MCG and search candidate cells, including the LTM cells for a cell that meets a cell selection criteria. The UE can select an LTM cell based on the selection criteria.

At 906, the method can include the UE transmitting, to the cell using an SRB1, an RRC re-establishment message, the RRC reestablishment message including a UE identifier and a failure cause. The failure cause can be an LTM reconfiguration failure or an LTM HO failure. The UE identifier can be a cell radio network temporary identifier (C-RNTI), or a short message authentication code integrity (short-MAC-I).

At 908, the method can include the UE recovering PDCP data for one or more SRBs and suspending PDCP data for one or more DRBs. In some instances, the method can further include the UE initiating a timer, receiving an RRC reconfiguration message prior to expiration of the timer, and determining to reestablish the DRBs based on the RRC reconfiguration message.

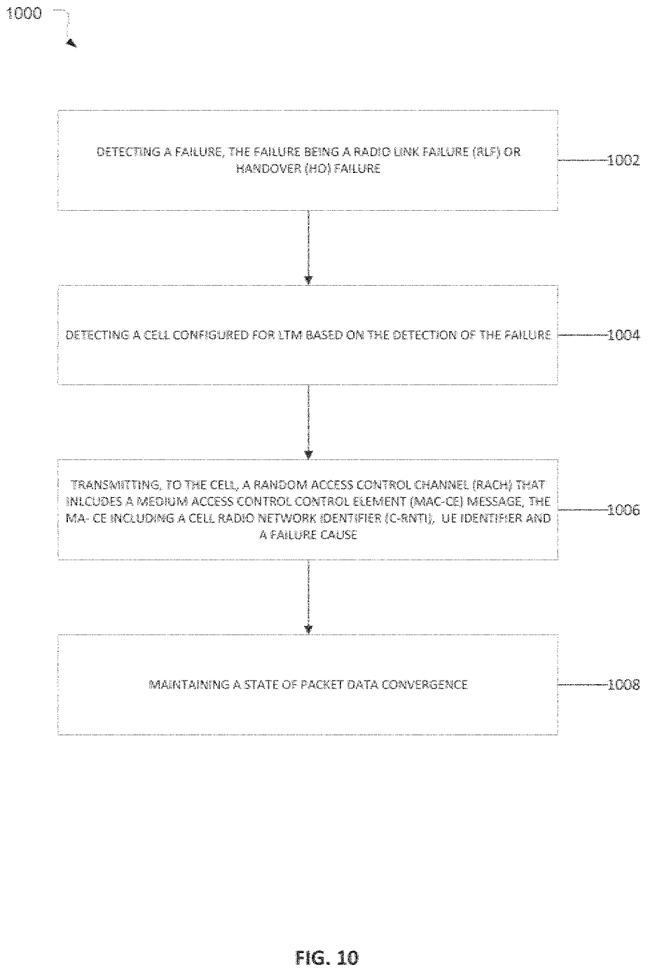

FIG. 10 is a process flow 1000 for MAC CE-based LTM failure handling in an MCG, according to one or more embodiments. At 1002, the method can include a UE detecting a failure, the failure being an RLF or a HO failure.

At 1004, the method can include the UE detecting a cell configured for LTM based on the detection of the failure. The UE configured with multiple candidate LTM cells in an MCG and search candidate cells, including the LTM cells for a cell that meets a cell selection criteria. The UE can select an LTM cell based on the selection criteria.

At 1006, the method can include the UE transmitting, to the cell, a RACH message that includes a MAC CE, the MAC CE including a C-RNTI, a UE identifier, and a failure cause. The failure cause can be an LTM HO failure, an LTM reconfiguration failure, or a RLF.

At 1008, the method can include the UE maintaining a state of a PDCP. In some instances, the method can further include the UE initiating a MAC timer, receiving an RRC reconfiguration message prior to expiration of the timer, and determining to reestablish the DRBs based on the RRC reconfiguration message.

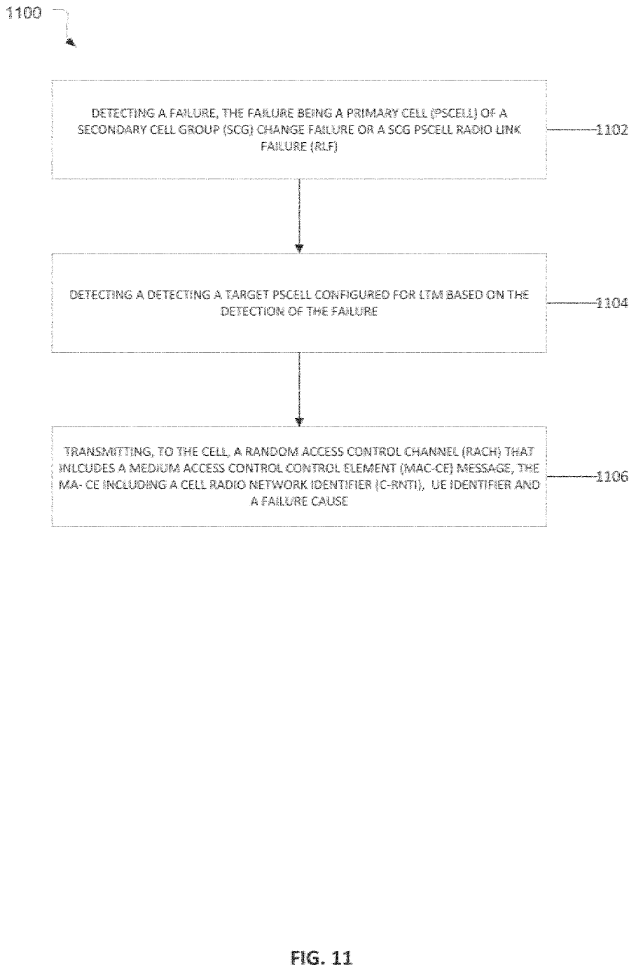

FIG. 11 is a process flow 1100 for MAC CE-based LTM failure handling in an SCG, according to one or more embodiments. At 1102, the method can include a UE detecting a failure, the failure being a PSCell of a SCG change failure or a SCG PSCell RLF.

At 1104, the method can include the UE detecting a target PSCell configured for LTM based on detecting the failure. The UE configured with multiple candidate LTM cells in an SCG and search candidate cells, including the LTM cells for a cell that meets a cell selection criteria. The UE can select an LTM cell based on the selection criteria.

At 1106, the method can include the UE transmitting, to the target PSCcell, a random access channel (RACH) message that includes a MAC CE, the MAC CE including a cell radio network temporary identifier (C-RNTI), a UE identifier, and a failure cause.

In some instances, the method can further include receiving an RRC reconfiguration message and reestablishing the one or more DRBs or an SRB3 based on the RRC reconfiguration message.

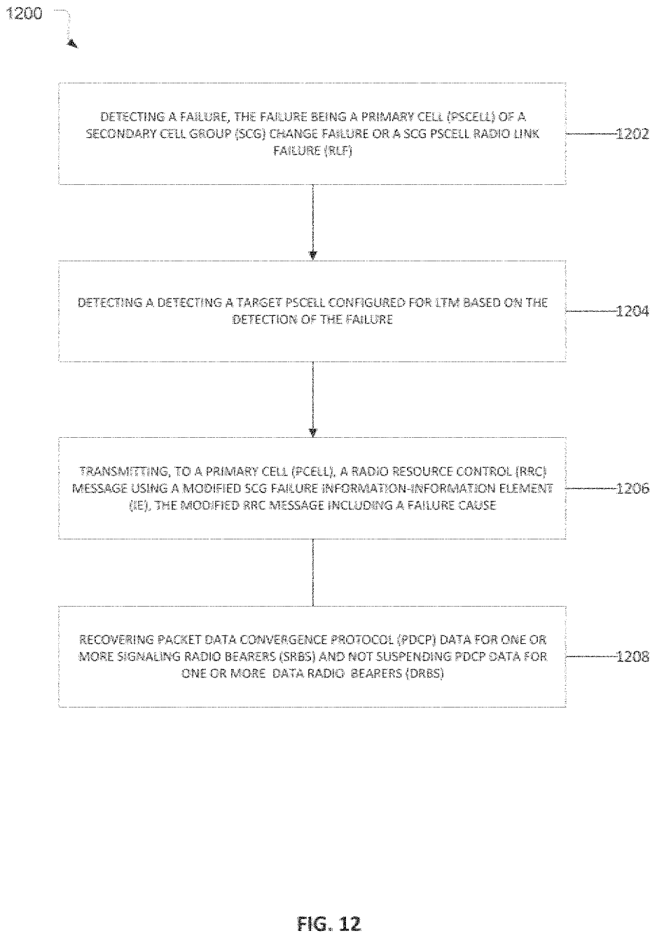

FIG. 12 is a process flow 1200 for RRC-based LTM failure handling in an MCG, according to one or more embodiments. At 1202, the method can include a UE detecting a failure, the failure being a PSCell of a SCG change failure or a SCG PSCell RLF.

At 1204, the method can include the UE detecting a target PSCell configured for LTM based on detecting the failure. The UE configured with multiple candidate LTM cells in a SCG and search candidate cells, including the LTM cells for a cell that meets a cell selection criteria. The UE can select an LTM cell based on the selection criteria.

At 1206, the method can include the UE transmitting, to a PCell, an RRC message using a modified SCG failure information-IE, the RRC message including a failure cause; and

At 1208, the method can include the UE recovering PDCP data for one or more SRBs and not suspending PDCP data for one or more DRBs. In some embodiments, the method can further include the UE transmitting measurements of candidate LTM cells to the PCell.

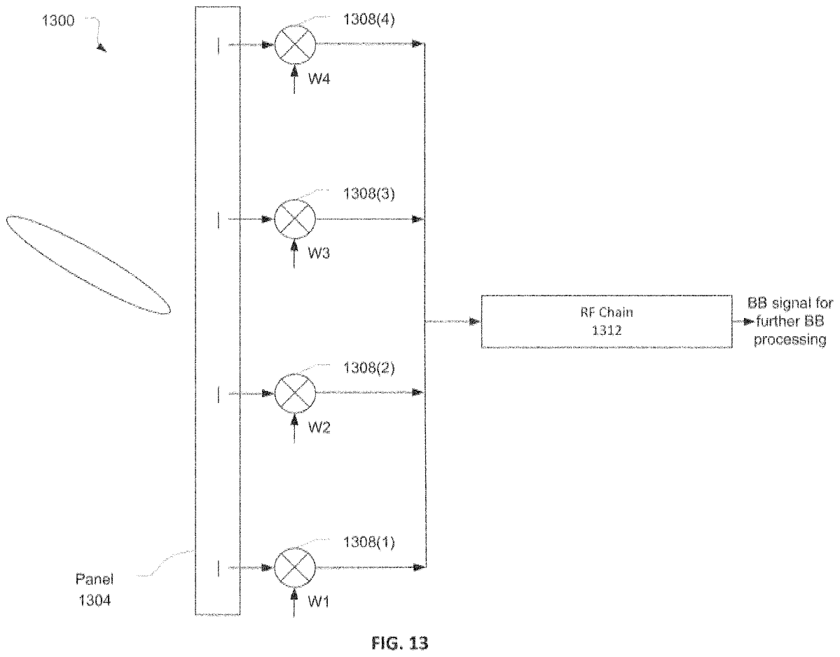

FIG. 13 illustrates receive components 1300 of the UE 1306, in accordance with some embodiments. The receive components 1300 may include an antenna panel 1304 that includes a number of antenna elements. The panel 1304 is shown with four antenna elements, but other embodiments may include other numbers.

The antenna panel 1304 may be coupled to analog beamforming (BF) components that include a number of phase shifters 1308(1)-1308(4). The phase shifters 1308(1) 1308(4) may be coupled with a radio-frequency (RF) chain 1312. The RF chain 1312 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (e.g., W1-W4), which may represent phase shift values, to the phase shifters 1308(1)-1308(4) to provide a receive beam at the antenna panel 1304. These BF weights may be determined based on the channel-based beamforming.

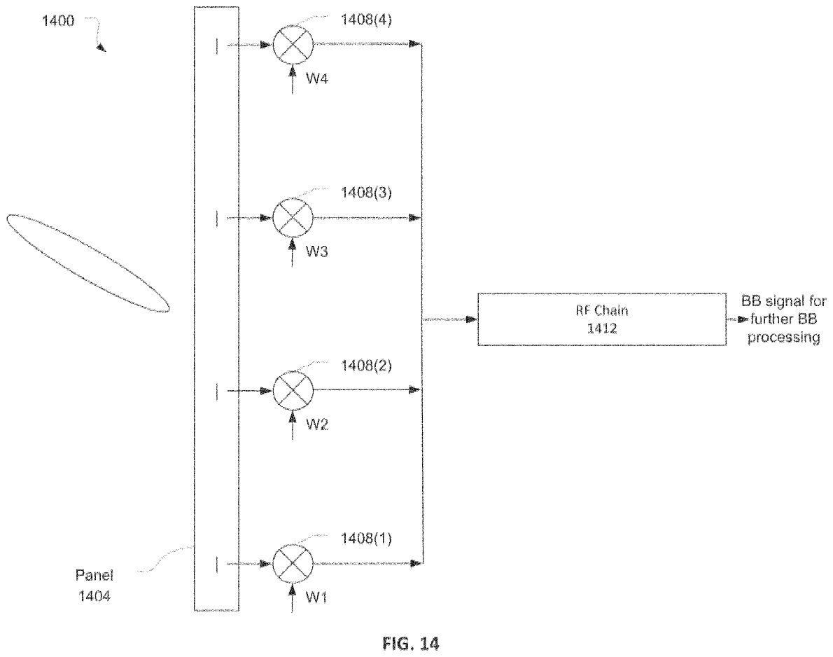

FIG. 14 illustrates a UE 1400, in accordance with some embodiments. The UE 1400 may be similar to and substantially interchangeable with UE 1306 of FIG. 13.

Similar to that described above with respect to UE 1400, the UE 1400 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 1400 may include processors 1404, RF interface circuitry 1408, memory/storage 1412, user interface 1416, sensors 1420, driver circuitry 1422, power management integrated circuit (PMIC) 1424, and battery 1428. The components of the UE 1400 may be implemented as integrated circuits (ICs), portions thereof, discrete electronic devices, or other modules, logic, hardware, software, firmware, or a combination thereof. The block diagram of FIG. 14 is intended to show a high-level view of some of the components of the UE 1400. However, some of the components shown may be omitted, additional components may be present, and different arrangements of the components shown may occur in other implementations.

The components of the UE 1400 may be coupled with various other components over one or more interconnects 1432, which may represent any type of interface, input/output, bus (local, system, or expansion), transmission line, trace, optical connection, etc. that allows various circuit components (on common or different chips or chipsets) to interact with one another.

The processors 1404 may include processor circuitry such as, for example, baseband processor circuitry (BB) 1404A, central processor unit circuitry (CPU) 1404B, and graphics processor unit circuitry (GPU) 1404C. The processors 1404 may include any type of circuitry or processor circuitry that executes or otherwise operates computer-executable instructions, such as program code, software modules, or functional processes from memory/storage 1412 to cause the UE 1400 to perform operations as described herein.

In some embodiments, the baseband processor circuitry 1404A may access a communication protocol stack 1436 in the memory/storage 1412 to communicate over a 3GPP compatible network. In general, the baseband processor circuitry 1404A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1408.

The baseband processor circuitry 1404A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 1404A may also access group information 1424 from memory/storage 1412 to determine search space groups in which a number of repetitions of a PDCCH may be transmitted.

The memory/storage 1412 may include any type of volatile or non-volatile memory that may be distributed throughout the UE 1400. In some embodiments, some of the memory/storage 1412 may be located on the processors 1404 themselves (for example, L1 and L2 cache), while other memory/storage 1412 is external to the processors 1404 but accessible thereto via a memory interface. The memory/storage 1412 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1408 may include transceiver circuitry and a radio frequency front module (RFEM) that allows the UE 1400 to communicate with other devices over a radio access network. The RF interface circuitry 1408 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 1424 and proceed to filter and amplify (with a low-noise amplifier) the signal. The signal may be provided to a receiver of the transceiver that down-converts the RF signal into a baseband signal that is provided to the baseband processor of the processors 1404.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1424.

In various embodiments, the RF interface circuitry 1408 may be configured to transmit/receive signals in a manner compatible with NR access technologies.

The antenna 1424 may include a number of antenna elements that each convert electrical signals into radio waves to travel through the air and to convert received radio waves into electrical signals. The antenna elements may be arranged into one or more antenna panels. The antenna 1424 may have antenna panels that are omnidirectional, directional, or a combination thereof to enable beamforming and multiple input, multiple output communications. The antenna 1424 may include microstrip antennas, printed antennas fabricated on the surface of one or more printed circuit boards, patch antennas, phased array antennas, etc. The antenna 1424 may have one or more panels designed for specific frequency bands including bands in FR1 or FR2.

The user interface circuitry 1416 includes various input/output (I/O) devices designed to enable user interaction with the UE 1400. The user interface 1416 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1400.

The sensors 1420 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1422 may include software and hardware elements that operate to control particular devices that are embedded in the UE 1400, attached to the UE 1400, or otherwise communicatively coupled with the UE 1400. The driver circuitry 1422 may include individual drivers allowing other components to interact with or control various input/output (I/O) devices that may be present within, or connected to, the UE 1400. For example, driver circuitry 1422 may include a display driver to control and allow access to a display device, a touchscreen driver to control and allow access to a touchscreen interface, sensor drivers to obtain sensor readings of sensor circuitry 1420 and control and allow access to sensor circuitry 1420, drivers to obtain actuator positions of electro-mechanic components or control and allow access to the electro-mechanic components, a camera driver to control and allow access to an embedded image capture device, audio drivers to control and allow access to one or more audio devices.

The PMIC 1424 may manage power provided to various components of the UE 1400. In particular, with respect to the processors 1404, the PMIC 1424 may control power-source selection, voltage scaling, battery charging, or DC-to-DC conversion.

In some embodiments, the PMIC 1424 may control, or otherwise be part of, various power saving mechanisms of the UE 1400. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1400 may power down for brief intervals of time and thus save power. If there is no data traffic activity for an extended period of time, then the UE 1400 may transition off to an RRC_Idle state, where it disconnects from the network and does not perform operations such as channel quality feedback, handover, etc.

The UE 1400 goes into a very low power state and it performs paging where again it periodically wakes up to listen to the network and then powers down again. The UE 1400 may not receive data in this state; in order to receive data, it must transition back to RRC Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1428 may power the UE 1400, although in some examples the UE 1400 may be mounted deployed in a fixed location, and may have a power supply coupled to an electrical grid. The battery 1428 may be a lithium ion battery, a metal-air battery, such as a zinc-air battery, an aluminum-air battery, a lithium-air battery, and the like. In some implementations, such as in vehicle-based applications, the battery 1428 may be a typical lead-acid automotive battery.

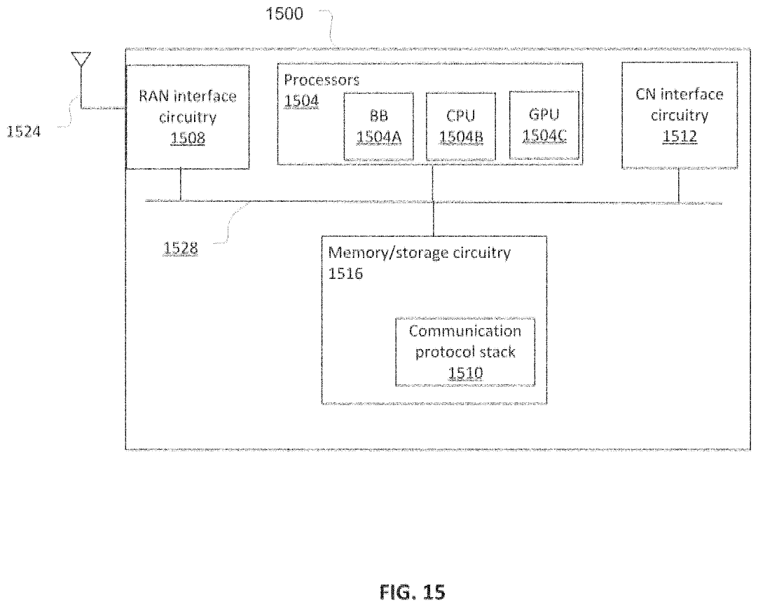

FIG. 15 illustrates a gNB 1500, in accordance with some embodiments. The gNB node 1500 may be similar to and substantially interchangeable with the base stations 154, 156 of FIG. 1.

The gNB 1500 may include processors 1504, RF interface circuitry 1508, core network (CN) interface circuitry 1512, and memory/storage circuitry 1516.

The components of the gNB 1500 may be coupled with various other components over one or more interconnects 1528.

The processors 1504, RF interface circuitry 1508, memory/storage circuitry 1516 (including communication protocol stack 1510), antenna 1524, and interconnects 1528 may be similar to like-named elements shown and described with respect to FIG. 13.

The CN interface circuitry 1512 may provide connectivity to a core network, for example, a 4th Generation Core network (5GC) using a 4GC-compatible network interface protocol such as carrier Ethernet protocols, or some other suitable protocol. Network connectivity may be provided to/from the gNB 1500 via a fiber optic or wireless backhaul.

The CN interface circuitry 1512 may include one or more dedicated processors or FPGAs to communicate using one or more of the aforementioned protocols. In some implementations, the CN interface circuitry 1512 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further example embodiments are provided.
Example 1 includes a method performed by a user equipment (UE) configured for layer 1/layer 2 triggered mobility (LTM), the method comprising: detecting a failure, the failure being a radio link failure (RLF) or a handover (HO) failure; detecting a cell configured for LTM based on the detection of the failure; transmitting, to the cell using a signaling radio bearer one (SRB1), a radio resource control (RRC) reestablishment message, the RRC reestablishment message including a UE identifier and a failure cause; and recovering packet data convergence protocol (PDCP) data for one or more signaling radio bearers (SRBs) and suspending PDCP data for one or more data radio bearers (DRBs).
Example 2 includes the method of example 1, wherein a radio link control (RLC) entity is terminated based on the failure, and wherein the method further comprises transmitting the RRC reestablishment message without reestablishing the RLC entity.
Example 3 includes the method of example 1 or 2, wherein the UE identifier is a cell radio network temporary identifier (C-RNTI) or a short message authentication code integrity (short-MAC-I).
Example 4 includes the method of any of examples 1-3, wherein the failure cause is an LTM reconfiguration failure or a LTM HO failure.
Example 5 includes the method of any of examples 1-4, wherein the method further comprises: initiating a timer; receiving an RRC reconfiguration message prior to expiration of the timer; and determining to reestablish the DRBs based on the RRC reconfiguration message Example 6 includes A user equipment (UE) configured for layer 1/layer 2 triggered mobility (LTM), comprising: one or more processors; a communication interface; radio frequency (RF) interface circuitry; and a computer-readable medium including instructions that, when executed by the one or more processors, cause the UE to perform one or more elements of a method described in or related to any of examples 1-5.
Example 7 includes a non-transitory computer-readable media comprising instructions to cause a network, upon execution of the instructions by one or more processors of the network, to perform one or more elements of a method described in or related to any of examples 1-5.
Example 8 includes a method performed by a user equipment (UE) configured for layer 1/layer 2 triggered mobility (LTM), the method comprising: detecting a failure, the failure being a radio link failure (RLF) or a handover (HO) failure; detecting a cell configured for LTM based on the detection of the failure; transmitting, to the cell, a random access channel (RACH) message that includes a medium access control-control element (MAC CE), the MAC CE including a cell radio network temporary identifier (C-RNTI), a UE identifier, and a failure cause; and maintaining a state of a packet data convergence protocol (PDCP) based on detecting the cell configured for LTM.
Example 9 includes the method of example 8, wherein the MAC CE further includes a preconfigured configuration identifier or a short-MAC-I.
Example 10 includes the method of examples 8 or 9, wherein the failure cause is an LTM HO failure, an LTM reconfiguration failure, or a radio link (RL) failure.
Example 11 includes the method of any of the examples 8-10, wherein the method further includes: initiating a MAC timer; receiving an RRC reconfiguration message prior to expiration of the timer; and determining to reestablish the one or more DRBs based on the RRC reconfiguration message.
Example 12 includes the method of any of examples 8-10, wherein the method further includes: initiating a MAC timer; and receiving a physical downlink control channel (PDCH) message that uses the C-RNTI prior to expiration of the timer.
Example 13 includes the method of any of examples 8-10, wherein the method further includes: initiating a MAC timer; and reporting the failure to RRC upon expiration of the MAC timer.
Example 14 includes the method of any of examples 8-13, wherein the MAC CE includes a physical cell identifier (PCI).
Example 15 includes the method of any of examples 8-13, wherein the MAC CE includes a preconfigured configuration identifier or a C-RNTI used prior to the failure.
Example 16 includes the method of any of examples 8-15, wherein the method further includes receiving a configuration from a network to either use RRC-based message or MAC CE-based message for RL failure handling.
Example 17 includes A user equipment (UE) configured for layer 1/layer 2 triggered mobility (LTM), comprising: one or more processors; a communication interface; radio frequency (RF) interface circuitry; and a computer-readable medium including instructions that, when executed by the one or more processors, cause the UE to perform one or more elements of a method described in or related to any of examples 8-16.
Example 18 includes a non-transitory computer-readable media comprising instructions to cause a network, upon execution of the instructions by one or more processors of the network, to perform one or more elements of a method described in or related to any of examples 8-16.
Example 19 includes a method performed by a user equipment (UE) configured for layer 1/layer 2 triggered mobility (LTM), the method comprising: detecting a failure, the failure being a primary cell (PSCell) of a secondary cell group (SCG) change failure or a SCG PSCell radio link failure (RLF); detecting a target PSCell configured for LTM based on detecting the failure; transmitting, to the target PSCell, a random access channel (RACH) message that includes a medium access control-control element (MAC CE), the MAC CE including a cell radio network temporary identifier (C-RNTI), a UE identifier, and a failure cause.
Example 20 includes a method of example 19, wherein the failure cause is an LTM handover (HO) failure or a LTM reconfiguration failure.
Example 21 includes a method of example 19 or 20, wherein the method further comprises: initiating a MAC timer; receiving an RRC reconfiguration message prior to expiration of the timer; and determining to reestablish the one or more DRBs based on the RRC reconfiguration message.
Example 22 includes a method of example 19 or 20, wherein the method further includes: initiating a MAC timer; and performing a legacy radio resource control (RRC) reestablishment procedure upon expiration of the MAC timer.
Example 23 includes A user equipment (UE) configured for layer 1/layer 2 triggered mobility (LTM), comprising: one or more processors; a communication interface; radio frequency (RF) interface circuitry; and a computer-readable medium including instructions that, when executed by the one or more processors, cause the UE to perform one or more elements of a method described in or related to any of examples 19-22.
Example 24 includes a non-transitory computer-readable media comprising instructions to cause a network, upon execution of the instructions by one or more processors of the network, to perform one or more elements of a method described in or related to any of examples 19-22.
Example 25 includes a method performed by a user equipment (UE) configured for layer 1/layer 2 triggered mobility (LTM), the method comprising: detecting a failure, the failure being a primary cell (PSCell) of a secondary cell group (SCG) change failure or a SCG PSCell radio link failure (RLF); detecting a target PSCell configured for LTM based on detecting the failure; transmitting, to a primary cell (PCell), a radio resource control (RRC) message using a modified SCG failure information-information element (IE), the RRC message including a failure cause; and recovering packet data convergence protocol (PDCP) data for one or more signaling radio bearers (SRBs) and not suspending PDCP data for one or more data radio bearers (DRBs).
Example 26 includes a method of example 25, wherein the method further includes receiving an RRC reconfiguration message; and reestablishing the one or more DRBs or an SRB3 based on the RRC reconfiguration message.
Example 27 includes A user equipment (UE) configured for layer 1/layer 2 triggered mobility (LTM), comprising: one or more processors; a communication interface; radio frequency (RF) interface circuitry; and a computer-readable medium including instructions that, when executed by the one or more processors, cause the UE to perform one or more elements of a method described in or related to examples 25 or 26.
Example 28 includes a non-transitory computer-readable media comprising instructions to cause a network, upon execution of the instructions by one or more processors of the network, to perform one or more elements of a method described in or related to examples 25 or 26.
Example 29 includes a method performed by a user equipment (UE) configured for layer 1/layer 2 triggered mobility (LTM), the method comprising: detecting a failure, the failure being a primary cell (PSCell) of a secondary cell group (SCG) change failure or an SCG PSCell radio link failure (RLF); detecting a target PSCell configured for LTM based on detecting the failure; performing a modified legacy SCG failure procedure, the modified SCG including transmitting an LTM failure cause.
Example 30 includes a method of example 29, wherein the further transmits measurements of candidate LTM cells.
Example 31 includes a user equipment (UE) configured for layer 1/layer 2 triggered mobility (LTM), comprising: one or more processors; a communication interface; radio frequency (RF) interface circuitry; and a computer-readable medium including instructions that, when executed by the one or more processors, cause the UE to perform one or more elements of a method described in or related to examples 29 or 30.
Example 32 includes a non-transitory computer-readable media comprising instructions to cause a network, upon execution of the instructions by one or more processors of the network, to perform one or more elements of a method described in or related to examples 29 or 30.
Example 33 includes a user equipment (UE) configured for layer 1/layer 2 triggered mobility (LTM), comprising: one or more processors; a communication interface; radio frequency (RF) interface circuitry; and a computer-readable medium including instructions that, when executed by the one or more processors, cause the UE to: detect a failure, the failure being a LTM radio link failure (RLF) or a LTM handover (HO) failure at a primary cell (PCell); detect a candidate cell configured for LTM based on the detection of the failure; and transmit, to the candidate cell using a signaling radio bearer one (SRB1), a radio resource control (RRC) reestablishment message, the RRC reestablishment message including a UE identifier and a failure cause; and recover packet data convergence protocol (PDCP) data for one or more signaling radio bearers (SRBs) and suspending PDCP data for one or more data radio bearers (DRBs).
Example 34 includes UE of example 33, wherein the instructions that, when executed by the one or more processors, cause the UE to initiate a timer for an LTM HO.
Example 35 includes a method including performing one or more elements of the method of examples 33 or 34.
Example 36 includes a non-transitory computer-readable media comprising instructions to cause a network, upon execution of the instructions by one or more processors of the network, to perform one or more elements of a method described in or related to examples 33 or 34.
Example 37 includes a user equipment (UE) configured for layer 1/layer 2 triggered mobility (LTM), comprising: one or more processors; a communication interface; radio frequency (RF) interface circuitry; and a computer-readable medium including instructions that, when executed by the one or more processors, cause the UE to: detect a failure, the failure being a primary cell (PSCell) of a secondary cell group (SCG) change failure or an SCG PSCell radio link failure (RLF); detect a candidate cell configured for LTM based on the detection of the failure; and transmit, to the target PSCell, a random access channel (RACH) message that includes a medium access control-control element (MAC CE), the MAC CE including a cell radio network temporary identifier (C-RNTI), a UE identifier, and a failure cause.
Example 38 includes a UE of example 37, wherein the instructions that, when executed by the one or more processors, further cause the UE to: initiate a MAC timer; receive an RRC reconfiguration message prior to expiration of the timer; and determine to reestablish the one or more DRBs based on the RRC reconfiguration message, wherein a configuration is based on the candidate cell.
Example 39 includes a method including performing one or more elements of the method of examples 37 or 38.
Example 40 includes a non-transitory computer-readable media comprising instructions to cause a network, upon execution of the instructions by one or more processors of the network, to perform one or more elements of a method described in or related to examples 37 or 38.
Example 41 includes a user equipment (UE) configured for layer 1/layer 2 triggered mobility (LTM), comprising: one or more processors; a communication interface; radio frequency (RF) interface circuitry; and a computer-readable medium including instructions that, when executed by the one or more processors, cause the UE to: generate a report indicating an LTM failure, the report being a self-organizing network (SON) report or a minimization of drive tests (MDT report); and transmitting the report to a network.
Example 42 includes a UE of example 41 wherein the LTM failure is an LTM handover (HO) failure or an LTM radio link failure (RLF).
Example 43 includes a method including performing one or more elements of the method of examples 41 or 42.
Example 44 includes a non-transitory computer-readable media comprising instructions to cause a network, upon execution of the instructions by one or more processors of the network, to perform one or more elements of a method described in or related to examples 41 or 42.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1.-28. (canceled)

29. A method comprising:
detecting a failure, the failure being a radio link failure (RLF) or a handover (HO) failure;
detecting a cell configured for layer 1 or layer 2 triggered mobility (LTM) based on the detection of the failure; and
generating, for transmission to the cell, a radio resource control (RRC) reestablishment message, the RRC reestablishment message including a UE identifier and a failure cause, the RRC reestablishment message generated based on detecting the cell configured for LTM.

30. The method of claim 29, wherein a radio link control (RLC) entity is terminated based on the failure, and wherein the method further comprises transmitting the RRC reestablishment message without reestablishing the RLC entity.

31. The method of claim 29, wherein the UE identifier is a cell radio network temporary identifier (C-RNTI) or a short message authentication code integrity (short-MAC-I).

32. The method of claim 29, wherein the failure cause is an LTM reconfiguration failure or an LTM HO failure.

33. The method of claim 29, further comprising:
initiating a medium access control (MAC) timer;
determining whether an RRC reconfiguration message is received prior to expiration of the MAC timer; and
based on whether an RRC reconfiguration message is received prior to expiration of the MAC timer:
performing a handoff procedure based on the RRC reconfiguration message in accordance with receiving the RRC reconfiguration message prior to expiration of the MAC timer; or
generating, for transmission, a message to an RRC layer to report the failure in accordance with not receiving the reconfiguration message prior to expiration of the MAC timer.

34. An apparatus comprising:
processor circuitry:
detect a failure, the failure being a radio link failure (RLF) or a handover (HO) failure;
detect a cell configured for layer 1 or layer 2 triggered mobility (LTM) based on the detection of the failure;
transmit, to the cell, a random access channel (RACH) message that includes a medium access control (MAC)-control element (CE), the MAC CE including a cell radio network temporary identifier (C-RNTI), a UE identifier, and a failure cause; and
maintain a state of a packet data convergence protocol (PDCP) based on detecting the cell configured for LTM; and
interface circuitry coupled to the processor circuitry to enable communication.

35. The apparatus of claim 34, wherein the MAC CE further includes a preconfigured configuration identifier or a short-medium access control (MAC)-identifier (I).

36. The apparatus of claim 34, wherein the failure cause is an LTM HO failure, an LTM reconfiguration failure, or a radio link (RL) failure.

37. The apparatus of claim 34, the processor circuitry further to:
initiate a MAC timer;
receive a radio resource control (RRC) reconfiguration message prior to expiration of the MAC timer; and
determine to reestablish the one or more data radio bearers (DRBs) based on the RRC reconfiguration message.

38. The apparatus of claim 34, the processor circuitry further to:
initiate a MAC timer; and
receive a physical downlink control channel (PDCH) message that uses the C-RNTI prior to expiration of the timer.

39. The apparatus of claim 34, the processor circuitry further to:
initiate a MAC timer; and
report the failure to an RRC layer upon expiration of the MAC timer.

40. The apparatus of claim 34, wherein the MAC CE includes a physical cell identifier (PCI).

41. The apparatus of claim 34, wherein the MAC CE includes a preconfigured configuration identifier or a C-RNTI used prior to the failure.

42. The apparatus of claim 34, wherein the method further includes receiving a configuration from a network to either use RRC-based message or MAC CE-based message for RL failure handling.

43. One or more non-transitory, computer-readable media having stored thereon instructions that, when executed, cause processor circuitry to:
detect a failure, the failure being a radio link failure (RLF) or a handover (HO) failure;
detect a cell configured for layer 1 or layer 2 triggered mobility (LTM) based on the detection of the failure;
transmit, to the cell, a random access channel (RACH) message that includes a medium access control (MAC)-control element (CE), the MAC CE including a cell radio network temporary identifier (C-RNTI), a UE identifier, and a failure cause; and
maintain a state of a packet data convergence protocol (PDCP) based on detecting the cell configured for LTM; and
interface circuitry coupled to the processor circuitry to enable communication.

44. The one or more non-transitory, computer-readable media of claim 43, wherein the MAC CE further includes a preconfigured configuration identifier or a short-medium access control (MAC)-identifier (I).

45. The one or more non-transitory, computer-readable media of claim 43, wherein the failure cause is an LTM HO failure, an LTM reconfiguration failure, or a radio link (RL) failure.

46. The one or more non-transitory, computer-readable media of claim 43, the processor circuitry further to:
initiate a MAC timer;
receive a radio resource control (RRC) reconfiguration message prior to expiration of the MAC timer; and
determine to reestablish the one or more data radio bearers (DRBs) based on the RRC reconfiguration message.

47. The one or more non-transitory, computer-readable media of claim 43, the processor circuitry further to:
initiate a MAC timer; and
receive a physical downlink control channel (PDCH) message that uses the C-RNTI prior to expiration of the timer.

48. The one or more non-transitory, computer-readable media of claim 43, the processor circuitry further to:
initiate a MAC timer; and
report the failure to an RRC layer upon expiration of the MAC timer.
